(19) United States
(12) Patent Application Publication
(10) Pub. No.: US 2026/0078767 A1
(43) Pub. Date: Mar. 19, 2026

(54) ASSEMBLY COMPRISING A RING AND A PIVOTING SUPPORT SLEEVE FOR VARIABLE PITCH VANE ROOTS, TURBINE ENGINE PROVIDED WITH SUCH AN ASSEMBLY AND METHOD FOR DISMANTLING SUCH AN ASSEMBLY

(71) Applicant: SAFRAN AIRCRAFT ENGINES, Paris (FR)

(72) Inventors: Vincent François Georges MILLIER, MOISSY-CRAMAYEL (FR); Olivier BELMONTE, MOISSY-CRAMAYEL (FR); Yves Roland CROCHEMORE, MOISSY-CRAMAYEL (FR); Didier René André ESCURE, MOISSY-CRAMAYEL (FR)

(73) Assignee: SAFRAN AIRCRAFT ENGINES, Paris (FR)

(21) Appl. No.: 19/101,639

(22) PCT Filed: Aug. 2, 2023
(86) PCT No.: PCT/FR2023/051231

§ 371 Date: Feb. 6, 2025

(30) Foreign Application Priority Data
Aug. 11, 2022 (FR) 2208246

(51) Int. Cl. F04D 29/32; F04D 29/64

(52) U.S. Cl. CPC F04D 29/323; F04D 29/646; F05D 2260/79

(57) ABSTRACT

An assembly for a turbine engine includes a ring with a rotationally symmetrical axis. The assembly further includes a plurality of support sleeves, each having a rotationally symmetrical axis and configured to receive a stud of a variable pitch blade. Each support sleeve includes a bore passing right through the support sleeve along the rotationally symmetrical axis. Each support sleeve is mounted on the ring so as to pivot about a pivot axis transverse to the radial axis and to the rotationally symmetrical axis.

### FIELD OF THE INVENTION

The present invention relates to the general field of aeronautic. In particular, it aims to integrate variable pitch vanes into a ring fitted to aircraft turbine engines. It also concerns the corresponding turbine engine and the corresponding dismantling method.

### TECHNICAL BACKGROUND

The variable pitch vanes may equip unducted propellers of turboprop engines or ducted fans of turbojet engine. By varying the pitch of the vanes around their axes, it is possible to improve the performance of the turbine engine while limiting the weight of the propulsion assembly. The variable pitch vanes allow the flow through them to be modified according to the operating conditions of the turbine engine and the phases of flight of the aircraft, either to brake the aircraft (thrust reversal) and/or to restore a pumping margin on turbine engines with a very high bypass ratio. Examples of variable pitch vanes are described in the documents U.S. Pat. Nos. 4,047,840, 8,075,270 B2, and US-A1-2016146025.

The variable pitch vanes are generally retained in a rotating hub by means of a pivot connection. The pivot connection is made by means of a stud of the variable pitch vane which is received in a housing in the hub. This type of connection allows to take account of the ratio between the aerodynamic moment at the level of the stud and the centrifugal force, which may not be sufficient to ensure that the stud is properly positioned on the hub.

An example of a stud for a variable pitch vane is shown in FIG. 1. The cylindrical stud 1A is mounted in a rotating manner in a housing 2A of a ring 3A about a pitch axis A. The ring 3A is attached to a rotor shaft 4A via a trunnion 5A and is centered on the longitudinal axis X of the turbine engine. The stud 1A is rotated by two rolling bearings 6A which are superimposed along the pitch axis A. The bearings 6A each comprise an inner ring 7A secured to the stud 1A and an outer ring 8A secured to the ring 3A. The radially outer end 9A of the stud is configured to be connected to an inner end of a radially outwardly extending blade and the radially inner end 10A of the stud is connected to a pitch change system 11A.

However, such a configuration means that it is difficult to dismantle the stud of the variable pitch vane following a damage. As the outer rings of the bearings are attached to the ring, the entire module, including the ring and the vanes, has to be removed for maintenance. The dismantling of the assembly is more necessary when the vanes are surrounded by an external casing. This lengthens the intervention time and results in economic loss.

### SUMMARY OF THE INVENTION

The aim of the present invention is to provide a solution allowing to facilitate the assembly and the dismantling of variable pitch vanes with a cylindrical root, particularly in the event of damage, while avoiding impacting the mass of the module comprising the vanes.

This objective is achieved in accordance with the invention by means of an assembly for a turbine engine, in particular of an aircraft, the assembly comprising a ring with an axis of revolution, the assembly comprising a plurality of support sleeves each having an axis of revolution and each configured to receive a stud of a variable pitch vane, each support sleeve comprising a bore passing through both sides of the support sleeve along the axis of revolution, each support sleeve being mounted so as to pivot on the ring about a pivot axis transverse to the radial axis and to the axis of revolution.

Thus, this solution allows to achieve the above-mentioned objective. In particular, such a configuration allows each variable pitch vane to be removed individually if it is damaged and/or needs to be checked. It is therefore no longer necessary to dismantle the assembly of the hub with the plurality of variable pitch vanes. In addition, this saves time during servicing, so that the turbine engine is not immobilized on the ground, for example, which in turn saves money. Added to this is the fact that repairing variable pitch vanes individually helps to reduce the environmental impact by avoiding the destruction of an assembly.

The assembly also comprises one or more of the following characteristics, taken alone or in combination:
each support sleeve pivots between a first position wherein the axis of revolution of the support sleeve is parallel to the radial axis and perpendicular to the axis of revolution, and a second position wherein the axis of revolution of the support sleeve is transverse to the radial axis.
the ring is equipped with a plurality of orifices passing through an annular wall of the ring along a radial axis and arranged regularly around the axis of revolution, and in that the ring comprises two ears which project on either side of each orifice, each support sleeve being installed between the two ears and pivoting on the ears along the pivot axis.
the ring extends between an upstream end and a downstream end along the axis of revolution of the ring, the ring comprising two ears which project in the vicinity of the upstream end, each support sleeve pivoting on the ears along the pivot axis.
the ring comprises mechanical reinforcement means, the mechanical reinforcement means comprising ribs which extend, on the one hand, between an upstream end and a downstream end of the ring along an axis of revolution and, on the other hand, along the radial axis, the ribs being disposed on either side of the orifices around the axis of revolution.
the assembly comprises a plurality of variable pitch vanes each equipped with a cylindrically shaped stud, each stud being mounted so as to pivot in the bore of a support sleeve about a pitch axis.
each variable pitch vane comprises a blade extending from the stud, the blade and the stud being formed in one-part.
each stud comprises an attachment at a radially outer end, the attachment being configured to receive a vane root and comprising a groove which extends along an axis perpendicular to the axis of the stud.
the assembly comprises attachment means which are configured so as to retain the support sleeve on the ring when the ring is in the first position.
the ring is equipped with a plurality of orifices passing through an annular wall of the ring along a radial axis and arranged regularly around the axis of revolution.
the stud of each vane is configured to pass through an orifice.
each support sleeve faces an orifice in the first position.
each support sleeve at least partially passes through an orifice in the second position.
each support sleeve is outside and spaced from an orifice in the second position.
the assembly comprises at least two rolling bearings each comprising an inner ring mounted on an outer wall of the stud and an outer ring configured to bear against a cylindrical inner wall of the bore of the support sleeve, the inner and outer rings defining raceways for rolling members.

The invention also relates to a turbine engine comprising such an assembly, a pitch change system connected to a radially inner end of a stud of each variable pitch vane and a rotor shaft connected to the ring.

The invention further relates to an aircraft comprising a turbine engine as mentioned above.

Finally, the invention relates to a method for dismantling an assembly as aforesaid, the method comprising the following steps:
removing the attachment means for attaching the support sleeve to the ring,
pivoting of the support sleeve along the pivot axis and upstream along the axis of revolution, and
extracting the stud of the support sleeve or the support sleeve of the ring.

According to the method, prior to the step of extracting the stud, the method comprises a step of disengaging the support sleeve relative to the ring at the level of the pivot axis.

Another characteristic of the method is that it comprises a step for tilting the support sleeve relative to the ring after the disengagement step.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is an axial cross-sectional view of an example of a cylindrical root according to the prior art;

FIG. 2 is a perspective view of a hub of variable pitch vanes which are ducted by an outer casing in accordance with the invention;

FIG. 3 is a perspective view of a ring configured to carry a plurality of variable pitch vanes according to the invention;

FIG. 4 is a detail view of an example of a ring configured to carry variable pitch vanes according to the invention;

FIG. 5 shows an embodiment of a ring and a support sleeve for supporting a variable pitch vane according to the invention;

FIG. 6 is a radial cross-sectional view of the ring and of the support sleeve of FIG. 4 according to the invention;

FIG. 7 shows another embodiment of a ring and of a support sleeve for supporting variable pitch vanes in accordance with the invention;

FIG. 8 is a detailed perspective view of a support sleeve configured to carry a variable pitch vane and located in a first position according to the invention;

FIG. 9 is a detailed perspective view of a support sleeve configured to carry a variable pitch vane and located in a second position according to the invention.

FIG. 10 illustrates a further embodiment of a vane and support sleeve according to the invention;

FIG. 11 shows a step for disengaging a support sleeve in a dismantling method according to the invention;

FIG. 12 shows a tilting step for a support sleeve in a dismantling method according to the invention;

FIG. 13 shows a tilting step in a disassembly method according to the invention; and

FIG. 14 shows a step for extracting and separating a support sleeve mounted on a vane in a dismantling method according to the invention.

### DETAILED DESCRIPTION OF THE INVENTION

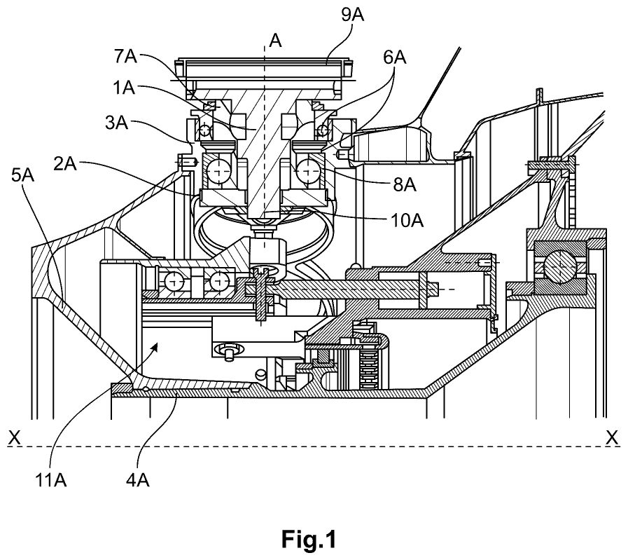

FIG. 1 shows a cylindrical stud for a variable pitch vane installed in a rotating ring of a turbine engine, which has already been described. FIG. 1 illustrates the technology prior to the present invention.

The invention applies to variable pitch vanes whose variation or pivoting is controlled by a pitch change system 40 and to all turbine engines equipped with these variable pitch vanes.

The turbine engine may be a turboprop engine comprising a plurality of unducted variable pitch vanes referred as an “open rotor” or a turbojet engine comprising a plurality of ducted variable pitch vanes referred as a “turbofan”. The turbine engine is configured to be mounted on an aircraft. Of course, variable pitch vanes may also be used on other machines such as wind turbines.

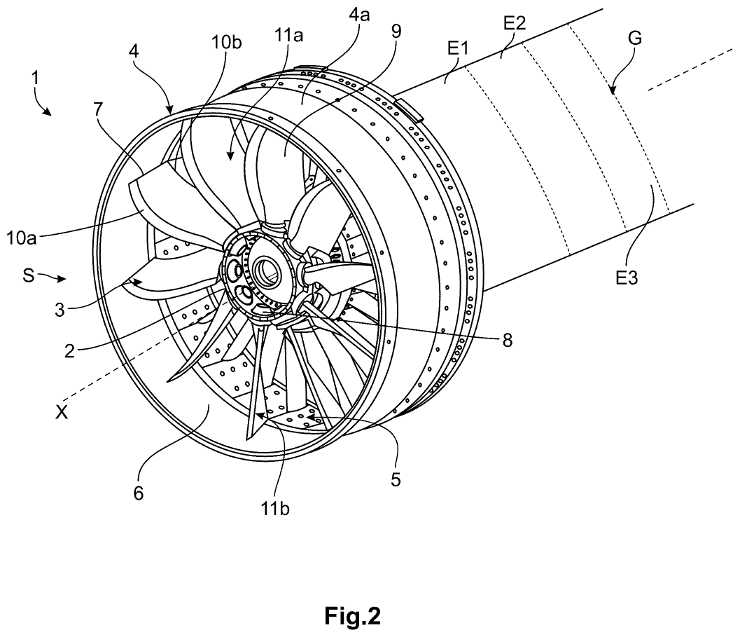

FIG. 2 illustrates a turbine engine 1 configured to equip an aircraft. The turbine engine generally comprises, from upstream to downstream along the gas flow and along a longitudinal axis X, a compressor assembly E1, an annular combustion chamber E2 and a turbine assembly E3. These assemblies form a gas generator G. The compressor and turbine assemblies comprise at least one compressor stage and at least one turbine stage respectively. In the case of a turbojet engine, this comprises a fan S comprising the variable pitch vanes and which is placed upstream of the compressor assembly E1. In a turboprop engine, one or more counter-rotating propellers, comprising the variable pitch vanes, are positioned either upstream of the compressor assembly (puller configuration) or downstream of the turbine assembly (pusher configuration).

In FIG. 2, a module of turbine engine 1, centered on the longitudinal axis X, comprises a ring 2 which carries a plurality of variable pitch vanes 3. This module is located upstream of the gas generator G, a rotor of which drives the plurality of variable pitch vanes about the longitudinal axis X. The variable pitch vanes 3 may have an inclination relative to a pitch axis A of the vane 3 that varies according to the engine speeds reached, so as to improve the aerodynamic performance and the efficiency of the turbine engine equipped with them.

Advantageously, but without limitation, the turbine engine module 1 comprises an outer casing 4 centered on the longitudinal axis X and surrounding the variable pitch vanes 3. The outer casing 4 comprises a cylindrical wall 4a with an inner surface 5 on which an abradable annular coating 6 is arranged. The latter is positioned opposite the free ends 7 of the vanes 3 and at a short distance from them. This short distance means that the abradable coating 6 may be worn away by friction with the vanes 3 as they rotate, limiting gas leakage at the free ends 7.

Each variable pitch vane 3 comprises a stud 8 and a blade 9 which extends along a radial axis Z outwards from the stud 8. The radial axis Z is perpendicular to the longitudinal axis X. Each blade 9 comprises a leading edge 10a and a trailing edge 10b which are connected by pressure side and suction side surfaces 11a, 11b.

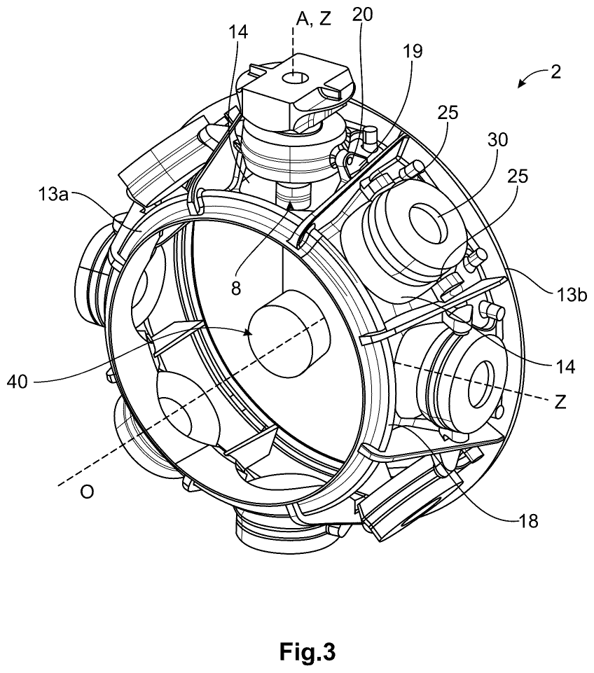

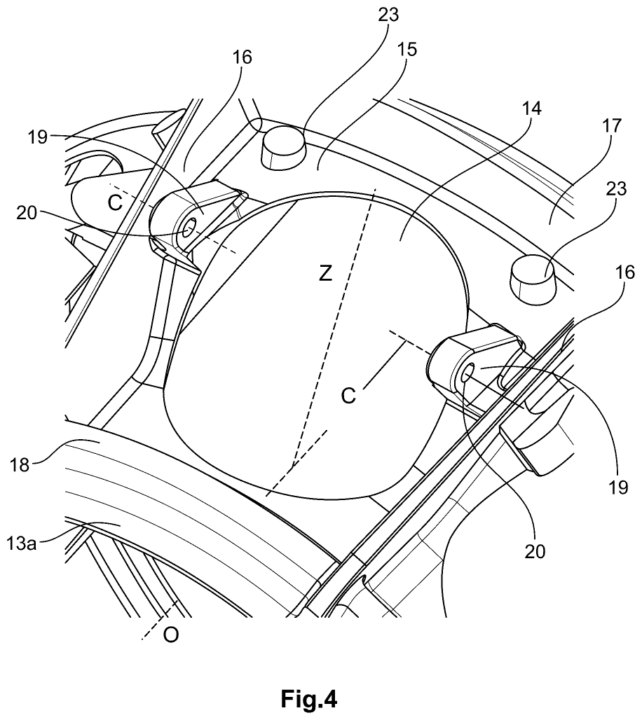

Referring to FIGS. 3 and 4, the stud 8 of each variable pitch vane is carried by the ring 2 via a support sleeve 12. The support sleeve 12 is removable and also mounted so that it may move along a pivot axis relative to the ring 2. In particular, each stud 8 is mounted so that it may pivot in a corresponding support sleeve 12 about its pitch axis A, and the pivoting of each support sleeve 12 makes it easier, on the one hand, to access the variable pitch vane 3 and, on the other hand, to extract it from the ring 2.

The ring 2 has an axis of revolution O which is centered on the longitudinal axis X of the turbine engine in the installation situation. In the embodiment shown in FIG. 3, the ring has a generally frustoconical annular wall 15. Alternatively, the annular wall 15 of the ring 2 has a cylindrical shape with a straight circular cross-section.

Advantageously, the ring 2 is mounted so that it may rotate about the longitudinal axis X. To this end, the ring 2 extends along its axis of revolution between an upstream end 13a and a downstream end 13b. The upstream end 13a is attached to a trunnion (not shown) which in turn is attached to a rotor shaft (not shown).

Advantageously, the small diameter of the frustoconical wall 15 is located towards the upstream end 13a and the large diameter of the frustoconical wall 15 is located towards the downstream end 13b. This allows the ring 2 to be better integrated into the turbine engine. The ring 2 comprises a plurality of orifices 14 which pass through the annular wall 15 of the ring 2 on either side along the radial axis. The orifices 14 are evenly spaced around the longitudinal axis X.

Advantageously, but without limitation, each orifice 14 has a generally rectangular shape with rounded or circular portions. More specifically, each orifice 14 has four portions with large radii which are connected to four portions with small radii (the large radii being greater than the small radii).

The ring 2 is equipped with mechanical reinforcement means configured to improve its mechanical strength. The mechanical reinforcement means comprise a number of ribs 16 which extend along both the radial axis Z and the longitudinal axis. In the example shown in FIG. 4, each rib 16 extends between an annular flange 17 and the upstream end 13a. The annular flange 17 also provides mechanical reinforcement for the ring 2. Alternatively, the ribs 16 also extend inwards from the annular wall. In this case, an inner ring would be mounted inside the ring 2, with the portion of the inner ribs connecting the walls of the rings. Advantageously, but without limitation, the annular flange 17 is centered on the axis of revolution O and extends along the radial axis. The annular flange 17 is also located upstream of the downstream end 13b of the ring 2.

Still referring to FIG. 4, we see that the ring 2 comprises a reinforcement structure 18 which is annular and centered on the longitudinal axis X. This reinforcement structure 18 comprises a U-shaped radial cross-section, the two branches of which are connected to the wall 15 of the ring 2. The aperture of the U-shaped section faces the inside of the ring 2. This reinforcement structure forms part of the mechanical reinforcement of the ring 2.

In this way, each orifice 14 is surrounded by ribs 16 which face each other in a circumferential direction around the longitudinal axis, the annular flange 17 and the reinforcing structure 18. The flanges, ribs and reinforcing structure form a box to reinforce the wall of the ring 2. The ribs 16 are arranged in an axisymmetric manner (or regularly around the axis of the turbine engine) so as to maintain a sufficient stiffness during operation of the turbine engine. The tangential forces pass through the ribs 16 as the variable pitch vanes 3 pivot about their pitch axis A.

With reference to FIGS. 3, 5 and 6, each support sleeve 12 is configured to receive the stud 8 of a variable pitch vane. Each support sleeve 12 comprises a cylindrical body 21 having an axis of revolution D. The axis of revolution is coaxial with the pitch axis A of each variable pitch vane 3 in the installation situation. Each support sleeve 12 is pivotally mounted on the ring 2 about a pivot axis C between a first position wherein the axis of revolution D of the support sleeve is parallel to the radial axis Z and a second position wherein the axis of revolution D of the support sleeve 12 is transverse to the radial axis Z.

In the present example of embodiment, the pivot axis C is transverse to the axis of revolution D. Advantageously, the pivot axis C is also transverse to the pitch axis A of each variable pitch vane 3. To this end, the ring 2 comprises two ears 19 which face each other in the circumferential direction. The ears 19 project substantially (plus or minus 10° of inclination) along the radial axis. In particular, the ear 19 are located on either side of each orifice 14 in the ring 2 in the circumferential direction. Each ear 19 comprises a bore 20 passing through its wall on either side along an axis transverse to the radial axis Z. The bores 20 in the ears define the pivot axis C of the support sleeve 12. In this example, the ears 19 are made in one piece with the wall 15 of the ring 2.

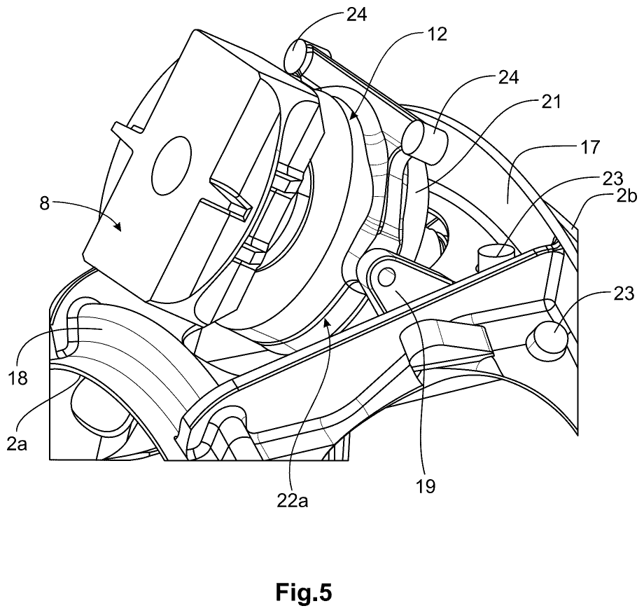

In the embodiment shown in FIGS. 5 and 6, the support sleeve 12 comprises two teats 25 (visible in FIG. 3) which extend radially with respect to a cylindrical outer wall 22a of the support sleeve 12. The teats 25 have coaxial axes. Each teat 25 is configured to engage in a corresponding bore 20 in a pivot connection to allow the support sleeve 12 to pivot about the pivot axis C. The axes of the teats 25 are defined in a median plane of the support sleeve 12, this median plane being perpendicular to the pitch axis. Each support sleeve 12 may pivot or tilt back and forth along the pivot axis C when the pitch vane 3 needs to be extracted. To extract the variable pitch vane, the support sleeve 12 is pivoted upstream.

Advantageously, but without limitation, the support sleeve 12 is maneuvered manually by an operator.

Each orifice 14 is large enough to allow the stud 8 and a part of the pitch system to pass through, which may be activated from the inside. These same orifices 14 are large enough to allow the support sleeve 12 and the blade 9 to pivot upstream. Advantageously, the support sleeve 12 is arranged at least partly above the corresponding orifice 14 along the axis of the orifice (substantially coaxial with the radial axis) and whatever the position of the support sleeve 12. Alternatively, a portion of the body of the sleeve 12 may extend inside the corresponding orifice 14 in the first position or in the second position.

An advantageous characteristic is that the dimensions of each orifice 14 are greater than the diameter of the support sleeve 12 (delimited by the cylindrical outer wall 22a). The perimeter of each orifice 14 is, for example, 5 times greater than the diameter of the support sleeve 12.

As shown in FIG. 5, attachment means are configured so as to retain the support sleeve 12 on the ring 2 and prevent it from pivoting during operation. The attachment is located downstream of the ring 2. More specifically, the attachment may be made by a threaded connection or a bayonet connection. The attachment means are advantageously located at two points downstream to ensure that the support sleeve 12 and the variable pitch vane are correctly positioned and retained on the ring 2. In the example shown, the attachment means comprise two through apertures 23 provided in the wall 15 of the ring 2. The apertures 23 pass through the wall 15 along the radial axis. The support sleeve 12 comprises two bases 24 which extend in projection from the cylindrical outer wall 22a of the support sleeve 12. These bases and apertures are configured to be passed through by screws, studs or threaded rods configured to cooperate with a nut, for example, to tighten the assembly.

As may be seen from the above and with reference to FIG. 6, each support sleeve 12 comprises a bore 30 which passes through it on either side along its axis of revolution D. The bore 30 forms a housing for the stud 8 of the vane 3. The stud 8 of each vane 3 is pivotally mounted in the bore 30 along the pitch axis A. The stud 8 is mounted in the support sleeve 12 and the latter is mounted on the ring 2 in such a way as to resist a detachment of the vane 3 during rotation of the ring 2 about the longitudinal axis. Each stud 8 extends along the pitch axis A. Advantageously, the stud 8 has a cylindrical shape. Advantageously, but without limitation, the stud 8 is straight cylindrical. By the expression “straight cylindrical shape” we mean a shape that is obtained by moving a generating line along a directing curve defined in a plane perpendicular to the generating line. The curve may be circular.

Each stud 8 comprises a radially outer end 31 (relative to the pitch axis A) which is connected to the blade 9. In the embodiments shown in FIGS. 3, 5 and 6, the radially outer end 31 secured to the blade 9, which is not shown in these figures. In other words, the stud 8 and the blade 9 are formed in one-part (integral).

Each stud 8 comprises a radially inner end 32 opposite the radially outer end 31. The stud 8 comprises a hole 34 which opens out at the level of this radially inner end 32. Advantageously, the hole 34 opens into a cavity by means of an opening 35. The hole 34 is centered on pitch axis A. In this example, the hole 34 is configured to receive a pitch transmission socket (not shown) configured to transmit the torsional torque to the stud 8 to change the pitch of the vane 3. The transmission socket is connected to the pitch change system 40 and is attached to the stud 8 by attachment means. The attachment means comprise, for example, a screw centered (passing through the opening 35) on the longitudinal axis and a nut tightened onto the screw. Other attachment means, such as threaded attachment, are of course also possible.

In order to set the vanes 3 about their pitch axis A, each stud 8 is pivotally mounted by means of at least two rolling bearings 36, 37. The bearings 36, 37 are superimposed along the pitch axis A. More specifically, each bearing 36, 37 comprises an inner ring secured to an outer wall 8a of the stud and an outer ring secured to a cylindrical inner wall 22b of the support sleeve 12. The cylindrical inner wall 22b is radially opposite the cylindrical outer wall 22a. The inner and outer rings define raceways for rolling members. The latter comprise balls or rollers. The bearings 36, 37 may be used to absorb the centrifugal forces (either along the pitch axis A) and/or the transverse forces (either in a plane perpendicular to the pitch axis A). Alternatively, the rolling members may also be balls. Retention means are provided to hold the bearings 36, 37 in the bore 30 and on the root, and a locking system is provided to hold these retention means in position.

The bearings 36, 37 and the stud 8 form a pivot for each variable pitch vane.

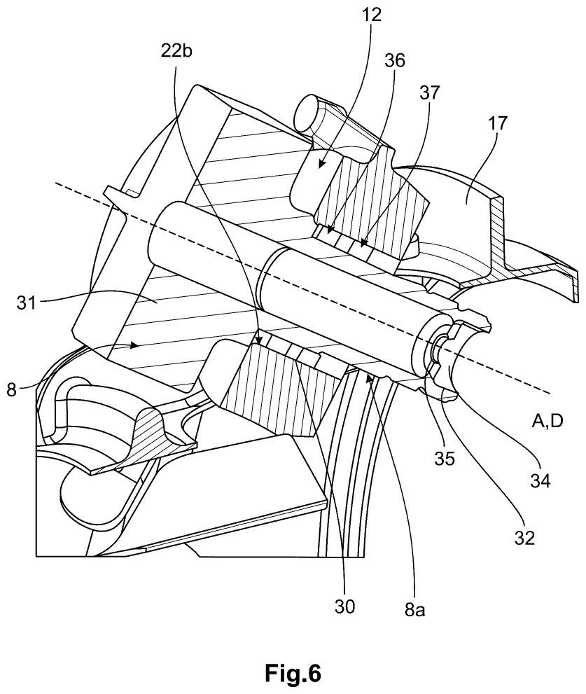

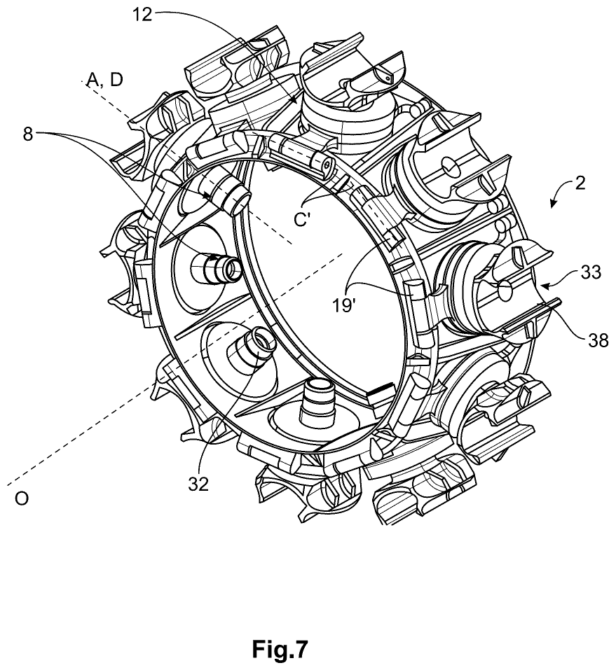

FIGS. 7 to 9 illustrate another embodiment for the ring 2 and the support sleeve 12 for the variable pitch vanes. In this example, the radially outer end 31 of the stud 8 comprises an attachment 33 configured to receive a blade root 9 (not shown). The vane 3 (formed in one-part with its root) and the stud 8 are formed from two separate pieces. In this example, the attachment 33 comprises a groove 38 which extends along an axis perpendicular to the axis of the stud 8. Advantageously, but without limitation, the groove 38 has a bulbous cross-section. The groove 38 opens upstream and downstream of the attachment 33 so that the root of the variable pitch vane may be inserted into the groove 38 from upstream to slide therein.

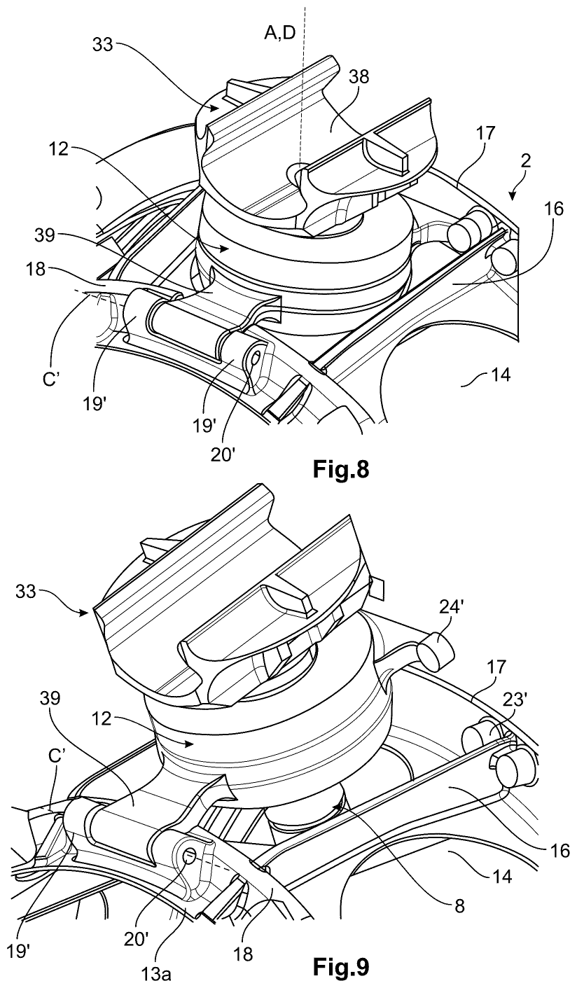

This embodiment also differs from the embodiment shown in FIGS. 3 to 6 in that the position of the pivot axis C′ is different. The pivot axis C′ is located upstream of the ring 2. More precisely, the pivot axis is defined by the bore 20′ of the two ears 19′ which project substantially radially from the wall 15 of the ring and in the vicinity of the upstream end 13a. Here the projections are arranged on the reinforcement structure 18. The support sleeve 12 comprises a bridge 39 which extends radially from the cylindrical outer wall 22a of the support sleeve 12. At its free end, the bridge 39 comprises a bore 42 (shown in dotted line in FIG. 11) which extends transversely on either side. In the installation situation, the axis of the bore 42 of the bridge 39 is coaxial with the bore 20′ of the ears 19′. A transverse shaft (not shown) is provided to pass through the bores 20′, 42 of the ears and the free end. Such a configuration is easy to dismantle. In this way, the support sleeve 12 may pivot between a first position wherein the pitch axis is coaxial with the radial axis (see FIG. 8) and a second position wherein the pitch axis is transverse to the radial axis (see FIG. 9). In the first position, the support sleeve 12 is inside at least part of the orifice 14, while in the second position, the support sleeve 12 is outside the orifice 14 and upstream of the ring 2.

In an alternative embodiment, the free end of the bridge 39 comprises transversely extending pins (not shown), each of which is configured to engage in a bore 20′ in the ears 19′ for pivoting the corresponding support sleeve.

This embodiment also differs in the arrangement of the attachment means. FIGS. 8 and 9 show that the axis of the attachment means extends along the longitudinal axis. In particular, the attachment means comprise two through apertures 23′ which pass through the radial flange 17 on either side along the longitudinal axis. The support sleeve 12 comprises two bases 24′ which project from the cylindrical outer wall 22a of the support sleeve 12. These bases and apertures are configured to be passed through by screws, studs or threaded rods configured to cooperate with a nut, for example, to tighten the assembly.

Each vane may be dismantled individually by extracting the root of the vane from the stud which remains in the support sleeve 12 if only the blade needs to be repaired and/or inspected. Of course, in the event of damage to the stud 8, it may be extracted from the support sleeve 12 by disengaging the transverse shafts from the ears. Beforehand, the attachment means are also dismantled to allow pivoting.

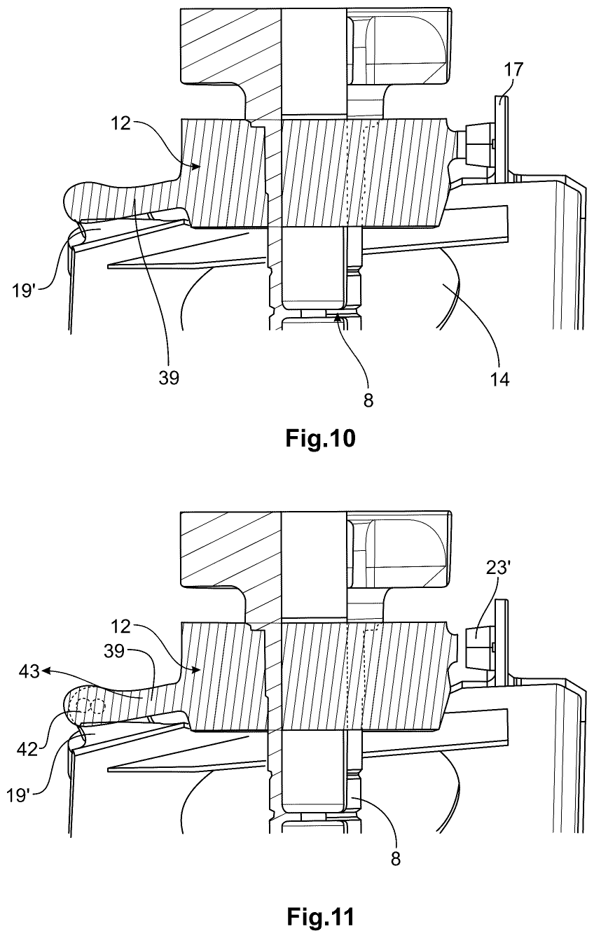

The following is a variant of the previous embodiment, illustrated in FIG. 10. In this variant, the stud 8 and the blade 9 are formed in one-part (integral). The blade 9 extends radially from the stud 8. The stud 8 is inserted into the support means 12, which is connected to the ring 2 by similar attachment means (screws and nuts or threaded elements) to the embodiments described above.

We will now describe an example of the method for mounting a vane stud on the ring 2.

The method comprises a step of assembling the stud 8 and the support sleeve 12. To do this, the inner rings of the two bearings are mounted on the stud 8 (for example by shrink-fitting). The outer ring of the rolling bearing which is outermost in relation to the axis of the stud 8 is mounted so as to bear transversely inside the bore 30 of the support sleeve 12. This is, for example, shrunk onto the cylindrical inner wall 22b of the support sleeve 12. The rolling members are then mounted on the outer ring.

The method comprises the step of inserting the stud 8 into the support sleeve 12. During this insertion, the stud 8 is inserted along the axis of the support sleeve 12 inside the corresponding bore 30.

The method then comprises a step for mounting the rolling members of the other innermost bearing and then its outer ring. The respective outer rings of the two rolling bearings are locked by tightening the retaining means. The anti-rotation systems are also fitted to prevent the retention means from moving. A further means for retaining the outer ring of the second bearing and its anti-rotation system are also fitted.

Of course, the outer rings may be previously mounted in the bore 30, followed by the inner rings on the stud 8. Similarly, the rolling members of the innermost bearing may be fitted first, followed by those of the outermost bearing.

The method comprises assembling the support sleeve 12 onto the ring 2. In the embodiment shown in FIGS. 3 to 6, the teats 25 are arranged to correspond with the bores 20 in the ears 19. The teats 25 are inserted into the bores to produce the pivot. In the embodiment shown in FIGS. 7 to 10, the bore 42 in the free end of the bridge 39 is arranged so as to correspond with the bore 20′ in the ears 19′, and the transverse shaft is then inserted through the bores for each support sleeve 12 so as to allow it to pivot. In the other embodiment shown in FIGS. 7 to 10, the teats are inserted into the bores of the ears 19 19′ so as to allow the support sleeve 12 to pivot relative to the ring 2.

The method then comprises the step of releasably attaching the support sleeve 12 to the ring 2. Advantageously, the threaded elements are inserted into the apertures and tightening elements are then mounted on the threaded elements to retain the support sleeve 12 on the ring 2, particularly during commissioning of the turbine engine and its operation. During this step, the support sleeve 12 is in the first position and is at least partly inside the orifice 14. Each stud 8 passes through a corresponding orifice 14 in the ring 2. Similarly, the radially inner end of the stud 8 is located inside the ring 2, towards the axis of revolution of the ring 2 and the longitudinal axis X of the turbine engine in the installation situation. The axis of revolution D of the support sleeve 12 is parallel to the radial axis in the first position.

When the stud 8 is equipped with an attachment 33, the root of the vane is inserted into the groove 38 before the support sleeve 12 is attached to the ring 2.

Once the support sleeve 12 is attached, each vane is connected to the pitch change system 40. To do this, the pitch transmission socket is inserted into the hole 34 in the stud 8 and then attached in the stud 8. The pitch transmission socket is then attached to the pitch change system 40 by suitable members to generate the rotation of the variable pitch vanes about the pitch axis A.

The assembly is dismantled by carrying out the steps described above in reverse. In particular, the dismantling method comprises removing the attachment means for attaching the support sleeve 12 to the ring 2. In this example, all you have to do is unscrew the screws and nuts on the first attachment members 45. The support sleeve 12 is tilted upstream so as to allow easy access to the stud 8. After tilting, the support sleeve 12 is in the second position and is outside the orifice 14, upstream of the ring 2.

The dismantling method then comprises extracting the stud 8 from the support sleeve 12 with the variable pitch vane.

In the case of the embodiment shown in FIG. 9, the method may comprise a step of extracting the blade from the attachment 33 prior to the pivoting step or even the step of removing the attachment means. Of course, the blade and its root may be extracted from the attachment after the support sleeve 12 has been pivoted.

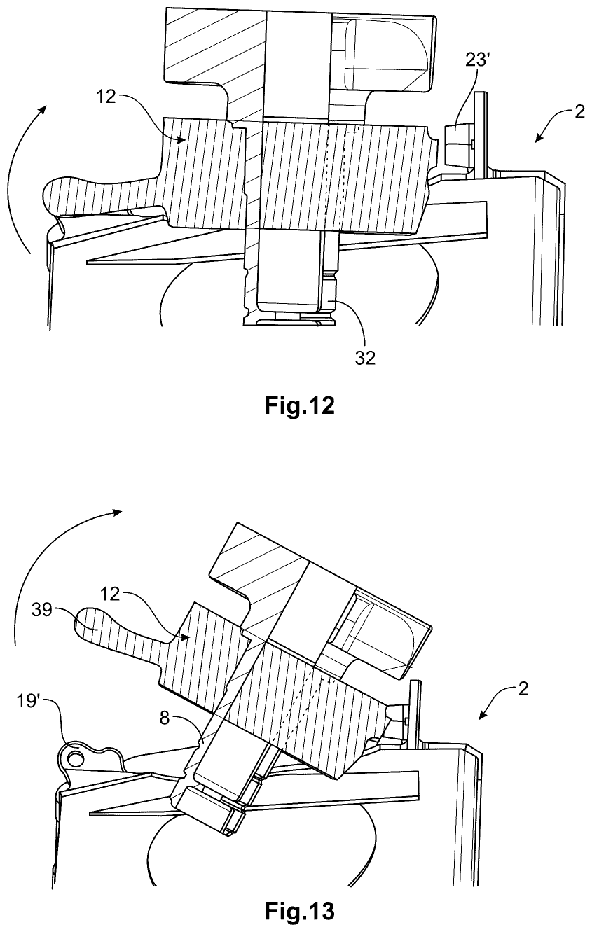

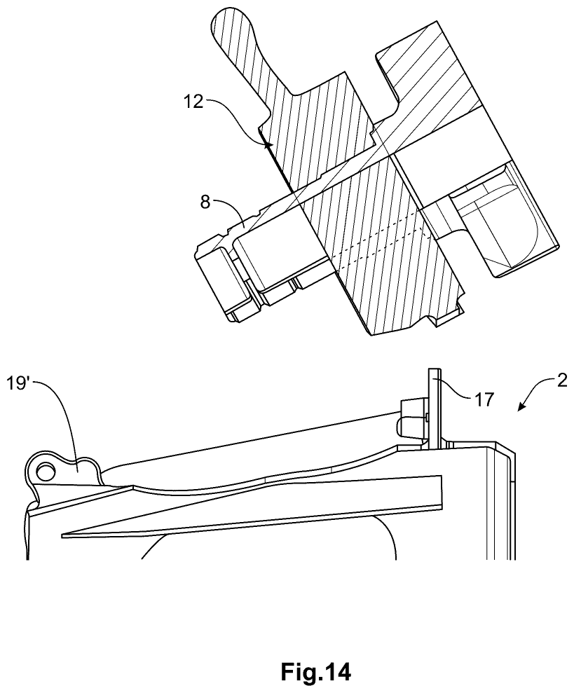

In the case of the embodiment shown in FIG. 10 (blade and stud in a single piece), the method comprises a step of disengaging the support sleeve 12 from the ring 2 at the level of the pivot axis C. This disengagement step is carried out by translating the support sleeve 12 upstream along the arrow 43 as shown in FIG. 11. To do this, the transverse shaft is first extracted from the bores of the ears 19 and that of the bridge 39 or the removal of the teats from the bores of the ears 19′. This disengagement step is followed by a tilting (rotation substantially about an axis transverse to the axis of the orifices 14) of the support sleeve 12 upstream as shown in FIGS. 12 and 13. FIG. 14 shows that the support sleeve 12 and the vane (stud 8 and blade) are now separated from the ring 12 for inspection or possible repair. The stud may also be separated from the support sleeve.

1. An assembly for a turbine engine, the assembly comprising a ring with an axis of revolution, a plurality of support sleeves each having an axis of revolution and each configured to receive a stud of a variable pitch vane, each support sleeve comprising a bore passing through both sides of the support sleeve along the axis of revolution, each support sleeve being mounted so as to pivot on the ring about a pivot axis transverse to a radial axis and to the axis of revolution.

2. The assembly according to claim 1, wherein each support sleeve pivots between a first position in which the axis of revolution of the support sleeve is parallel to the radial axis and perpendicular to the axis of revolution, and a second position, in which the axis of revolution of the support sleeve is transverse to the radial axis.

3. The assembly according to claim 1, wherein the ring is equipped with a plurality of orifices passing through an annular wall of the ring along the radial axis and arranged regularly around the axis of revolution, the ring comprising two ears which project on either side of each orifice, each support sleeve being installed between the two ears and pivoting on the ears along the pivot axis.

4. The assembly according to claim 1, wherein the ring extends between an upstream end and a downstream end along the axis of revolution of the ring, the ring comprising two ears which project in the vicinity of the upstream end, each support sleeve pivoting on the ears along the pivot axis.

5. The assembly according to claim 1, wherein the ring comprises mechanical reinforcement means, the mechanical reinforcement means comprising ribs which extend, on the one hand, between an upstream end and a downstream end of the ring along an axis of revolution and, on the other hand, along the radial axis, the ribs being disposed on either side of the orifices around the axis of revolution.

6. The assembly according to claim 1, further comprising a plurality of variable pitch vanes each equipped with a cylindrical stud, each stud being mounted so as to pivot in the bore of a support sleeve about a pitch axis.

7. The assembly according to claim 6, wherein each variable pitch vane comprises a blade which extends from the stud, the blade and the stud being formed in one-part.

8. The assembly according to claim 6, wherein each stud comprises an attachment at a radially outer end, the attachment being configured to receive a vane root and comprising a groove which extends along an axis perpendicular to the axis of the stud.

9. The assembly according to claim 2, further comprising attachment means configured so as to retain the support sleeve on the ring when the ring is in the first position.

10. The assembly according to claim 3, wherein each support sleeve pivots between a first position in which the axis of revolution of the support sleeve is parallel to the radial axis and perpendicular to the axis of revolution, and a second position, in which the axis of revolution of the support sleeve is transverse to the radial axis, and wherein each support sleeve faces an orifice in the first position and at least partially passes through an orifice in the second position.

11. The assembly according to claim 3, wherein each support sleeve pivots between a first position in which the axis of revolution of the support sleeve is parallel to the radial axis and perpendicular to the axis of revolution, and a second position, in which the axis of revolution of the support sleeve is transverse to the radial axis, and wherein each support sleeve is outside and spaced from an orifice in the second position.

12. The assembly according to claim 1, wherein the assembly further comprises at least two rolling bearings each comprising an inner ring mounted on an outer wall of the stud and an outer ring configured to bear against a cylindrical inner wall of the bore of the support sleeve, the inner and outer rings defining raceways for rolling members.

13. A turbine engine comprising the assembly according to claim 1, a pitch change system connected to a radially inner end of a stud of each variable pitch vane and a rotor shaft connected to the ring.

14. A method for dismantling the assembly according to claim 1, the method comprising the following steps:
removing the attachment means for attaching the support sleeve to the ring,
pivoting the support sleeve along the pivot axis and upstream along the axis of revolution, and
extracting the stud from the support sleeve.

15. The method according to claim 14, further comprising, prior to the step of extracting the stud, a step of disengaging the support sleeve relative to the ring at the level of the pivot axis.
